(19) United States
(12) Patent Application Publication
(10) Pub. No.: US 2025/0321554 A1
(43) Pub. Date: Oct. 16, 2025

(54) REMOTE CONFIGURATION, INITIATION, AND MANAGEMENT OF UNLOADING OPERATIONS

(71) Applicant: Deere & Company, Moline, IL (US)

(72) Inventors: Riley J. Wegmann, Urbana, IL (US); Stephen R. Corban, Geneseo, IL (US)

(21) Appl. No.: 18/634,301

(22) Filed: Apr. 12, 2024

(51) Int. Cl. G05B 19/04

(52) U.S. Cl. CPC G05B 19/041

(57) ABSTRACT

An unloading configuration approval request describes characteristics of an unload operation that is to be performed. The unloading configuration approval request is sent from a material transfer vehicle to a remote system. A user or operator at the remote system can accept, cancel, or modify the unloading configuration approval request. To modify the request, the operator changes unloading parameters and transmits the changed unloading parameters back to the material transfer vehicle. When the unloading configuration approval request is approved at the remote location, the material transfer vehicle performs the unloading operation according to the approved unloading configuration.

### FIELD OF THE DESCRIPTION 3

The present description relates to agricultural equipment. More specifically, the present description relates to automatically approving and/or configuring an unloading operation from a remote location.

### BACKGROUND

There are a wide variety of different types of agricultural equipment. Some such agricultural equipment includes agricultural harvesters. Agricultural harvesters often engage crop and process that crop, and unload that crop into a material transfer vehicle, such as a tractor-pulled grain cart (for example).

Once the grain cart is filled to a desired fill level, a propulsion vehicle (such as a tractor or other vehicle) that pulls the grain cart transfers the harvested material to a container, such as a semi-trailer. The propulsion vehicle approaches the semi-trailer, positions an unloading spout or auger, pulls alongside the semi-trailer, and then engages the unloading auger on the grain cart to unload the harvested material from the grain cart into the semi-trailer.

The discussion above is merely provided for general background information and is not intended to be used as an aid in determining the scope of the claimed subject matter.

### SUMMARY

An unloading configuration approval request describes characteristics of an unload operation that is to be performed. The unloading configuration approval request is sent from a material transfer vehicle to a remote system. A user or operator at the remote system can accept, cancel, or modify the unloading configuration approval request. To modify the request, the operator changes unloading parameters and transmits the changed unloading parameters back to the material transfer vehicle. When the unloading configuration approval request is approved at the remote location, the material transfer vehicle performs the unloading operation according to the approved unloading configuration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram of one example of an agricultural system.

FIG. 2 is a block diagram showing one example of a material transfer vehicle unload configuration/approval system in more detail.

FIG. 3 is a flow diagram illustrating one example of the operation of the material transfer vehicle unload configuration/approval system.

FIG. 4 is a block diagram showing one example of a remote system unload configuration/modification/approval system in more detail.

FIG. 5 is a flow diagram illustrating one example of the operation of the remote system unload configuration/modification/approval system.

FIGS. 6, 7, 8, and 9 are examples of user interfaces that can be generated.

FIG. 10 is a block diagram showing one example of the agricultural system illustrated in FIG. 1, deployed in a remote server architecture.

FIGS. 11, 12, and 13 are examples of mobile devices that can be used in the systems and architectures in other figures.

FIG. 14 is a block diagram showing one example of a computing environment that can be used in architectures and systems shown in other figures.

### DETAILED DESCRIPTION

As discussed above, it is not uncommon for a material transfer vehicle (such as a tractor pulled grain cart, for example) to transfer material from an agricultural harvester to a container, such as a semi-trailer. Once at the semi-trailer, the material transfer vehicle performs an unloading operation in which material is conveyed from the grain cart to the semi-trailer. The configuration of the unloading operation may be characterized by a variety of different configuration parameters. For instance, the configuration parameters may identify the particular type of container, into which the material transfer vehicle is expecting to unload material. The identity of the container may identify such things as the type of semi-trailer (e.g., single hopper bottom, double hopper bottom, etc.), the target weight of the material that the material transfer vehicle wishes to transfer to the container (e.g., the weight of the grain to be transferred), the target fill distribution (e.g., the target fill level that the material transfer vehicle expects to achieve during the unloading operation, the direction of the unloading operation or fill pattern e.g., front-to-back, back-to-front, multi-pass, etc. the side of the container or truck that the material transfer vehicle expects to approach e.g., driver side, passenger side, left or right side, etc.), among other things.

These types of parameters may change throughout the year and may even change from one load to another during the same harvesting operation. For instance, the weight of the material (given the same volume in a grain cart) may change based upon the crop type, the crop moisture, etc.

However, in some scenarios, there are reasons that the unloading operation should not be performed, as it is presently configured. For instance, there may be weight limits by which a semi-truck must abide. The weight limits may change based upon the roads that are to be traveled, the time of the year, etc. Further, the unloading configuration may be based upon assumptions that are incorrect. For instance, assume that the unloading configuration indicates that the material transfer vehicle is to approach the semi-trailer on the left side of the truck. However, assume further that the terrain on the right side of the truck is better for unloading (e.g., less muddy, more level, smoother, etc.) than the terrain on the right side. In such a scenario, it may be beneficial to change the unloading configuration to reflect that the material transfer vehicle should approach the semi-trailer on the right side, rather than the left side. Further, the unloading configuration may define a particular fill level or distribution that can be achieved when, in fact, the semi-trailer operator or other user may prefer a different distribution or a different fill level.

The present description thus proceeds with respect to a system that generates an unloading configuration approval request displaying configuration parameters that define portions of the unloading operation. The unloading configuration approval request is transmitted from the material transfer vehicle to a remote system (such as to a handheld device used by the operator of the semi-truck, to a farm manager system), or to another remote system, and displayed. The unloading configuration approval request can then be approved, cancelled, or modified by the 27 operator or user at the remote system.

When the operator or user at the remote system elects to modify the approval request, then the operator or user is navigated through a user experience which allows the operator or user to change or modify the configuration parameters. The changed or modified configuration parameters are then sent back to the material transfer vehicle which re-generates a new unloading configuration approval request with the changed parameters. The new approval request is again sent to the remote system for approval. Once the unloading configuration approval request is approved, notification of that is sent back to the material transfer vehicle which can then commence the unloading operation, according to the approved configuration.

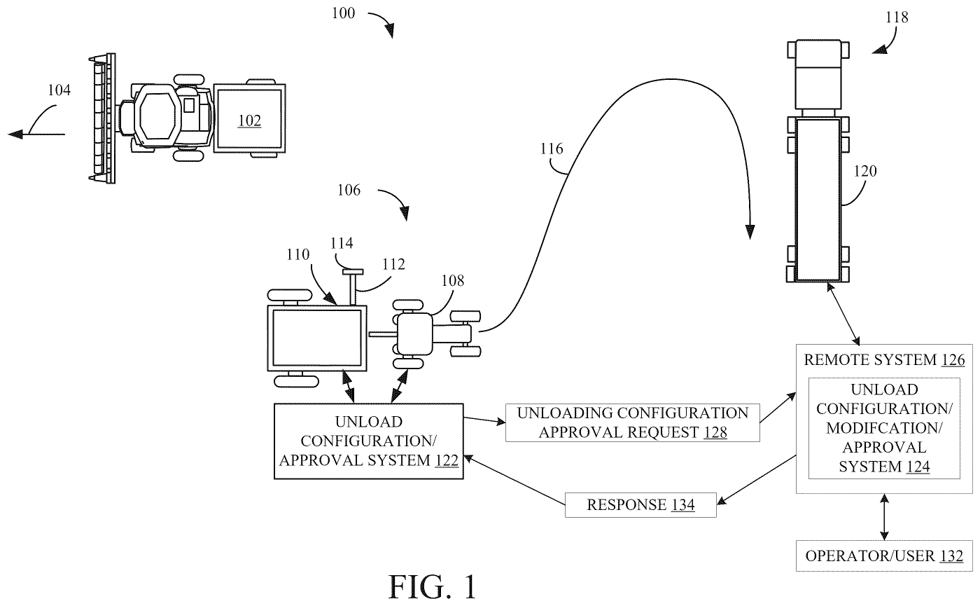

FIG. 1 is a partial pictorial, partial block diagram of one example of an agricultural system 100 in which a harvester 102 is moving through a field in a direction indicated by arrow 104. A material transfer vehicle 106 includes a propulsion vehicle (e.g., a tractor) 108 and a grain cart 110. Grain cart 110 is shown having an auger 112 and a spout 114 that are used to unload harvested material from grain cart 110. In the example shown in FIG. 1, grain cart 110 has been filled with harvested material from harvester 102 and is traveling along a travel path indicated by arrow 116 toward a container (e.g., a semi-truck) 118. In order to unload material from grain cart 110, tractor 108 will pull the grain cart 110 alongside of semi-trailer 120 so that the auger 112 can be engaged to transfer material from grain cart 110 into semi-trailer 120. In one example, auger is driven by a power takeoff on tractor 108.

Also, in the example shown in FIG. 1, unload configuration/approval system 122 corresponding to material transfer vehicle 106 is deployed on tractor 108, grain cart 110, or in a remote server environment, or disposed among a plurality of different locations. Also, an unload configuration/modification/approval system 124 is disposed on a remote system 126. Remote system 126 can be deployed on a hand-held device carried by the operator of semi-truck 118, deployed on a system mounted to a dashboard or console in the operator compartment of semi-trailer 118, or at another remote system, such as farm manager system, in a remote server environment, or another remote system.

Unload configuration/approval system 122, as described in greater detail below, can be part of an overall control system, an intermediary system, a standalone system, a distributed system, or another system 122. The functionality of system 122 is described as a separate system for the sake of example only. System 122 generates an unloading configuration approval request 128 which includes a plurality of configuration parameters describing portions of the unloading operation that will be performed to unload material from grain cart 110 into semi-trailer 120. Unload configuration/approval system 122 generates approval request 128 and sends that approval request 128 to remote system 126 based upon a detected trigger. The detected trigger may include machine transfer vehicle 106 reaching a predefined point or location 130. Location 130 may be defined relative to the location of semi-trailer 120, or as coordinates within a field, or as another predefined location. Other trigger criteria can be used as well. Once triggered, unload configuration/approval system 122 sends the unload configuration approval request 128 to unload configuration/modification/approval system 124 on remote system 126.

The operator or user 132 of remote system 126 can then respond to approval request 128 by approving it, modifying it, or cancelling it. Such a response 134 is sent back from system 124 to system 122. If response 134 indicates that operator/user 132 has approved the request 128, then material transfer vehicle 106 commences the unload operation according to the configuration, as approved. If response 134 indicates that the operator/user 132 has cancelled the unload operation, then material transfer vehicle 106 can simply wait at a desired location to receive further instructions or proceed to a different semi-trailer or container, or proceed in other ways. If operator/user 132 wishes to modify the approval request 128, then unload configuration/modification/approval system 124 generates a user interface through which operator/user 132 can modify the unload configuration parameters as desired. Those modified parameters are then sent back with response 134 to unload configuration/approval system 122. System 122 then re-generates another unloading configuration approval request 128 based on the changed or modified parameters in response 134. The re-generated approval request 128 is again displayed or otherwise surfaced for approval by operator/user 132. Once an approval request 128 is approved, then material transfer vehicle 106 performs the unloading operation according to the configuration defined by the approved, modified parameters.

In one example, systems 122 and 124 may be applications, mobile applications, or web applications that are downloaded to mobile devices or hosted in a remote server environment (such as in the cloud) or in other computing systems. The systems 122 and/or 124 may also be embedded systems within the different vehicles, or systems in agricultural system 100. Systems 122 and 124 can take other forms as well.

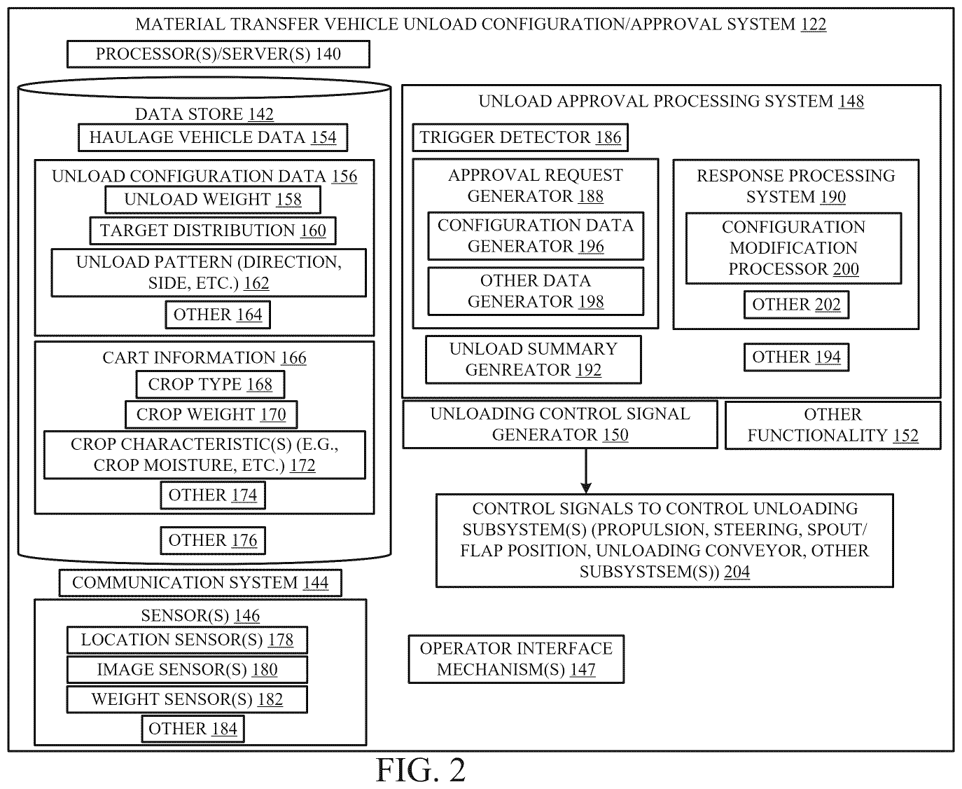

FIG. 2 is a block diagram showing one example of the material transfer vehicle unload configuration/approval system 122 (system 122 or approval system 122) in more detail. In the example shown in FIG. 2, system 122 includes one or more processors or servers 140, data store 142, communication system 144, sensors 146, operator interface mechanism(s) 147, unload approval processing system 148, control signal generator 150, and other functionality 152. Data store 142 can include haulage vehicle data 154, unload configuration data 156 (which may include such things as unload height 158, target distribution 160, unload pattern-direction, side of truck, front-to-back, back-to-front, etc. 162, and other unload configuration data 164), cart information 166 (which can include crop type 168, crop weight 170, crop characteristics, such as crop moisture, etc. 172, and other items 174), and any of a variety of other data items 176. Sensors 146 can include location sensor 178, image sensor 180, weight sensor 182, and other sensors 184. Unload approval processing system 148 can include trigger detector 186, approval request generator 188, response processing system 190, unload summary generator 192, and other items 194. Approval request generator 188 can include configuration data generator 196, and other data generator 198. Response modification system 190 can include configuration modification processor 200 and other items 202. Also, in FIG. 2, unload control signal generator 150 is shown generating control signals 204 to control unloading subsystems on material transfer vehicle 106, such as a propulsion subsystem, a steering subsystem, a spout/flap position system, an unloading conveyor, and other subsystems. Before describing the overall operation of system 122 in more detail, a description of some of the items in system 122, and their operation, will first be described.

Haulage vehicle data 154 can include data describing the haulage vehicle or other container into which material transfer vehicle 106 is to transfer material. For instance, the haulage vehicle data 154 can include a description of the haulage vehicle, such as two hopper bottom trailer, the make and model of the haulage vehicle, the weight capacity of the haulage vehicle, the number of axles, the target fill height or fill distribution for the haulage vehicle, among other things. Unload configuration data 156 may include the unload configuration parameters that describe the desired unload operation. Such parameters can include the unload weight 158 of material to be transferred, the target distribution (e.g., identifying the fill height of material across the width and length of the semi-trailer, etc.), the unload pattern 162 (such as whether the pattern is a back-to-front pattern, a front-to-back pattern, a multi-pass pattern, the side that material transfer vehicle 106 is to approach the haulage vehicle), among other things.

Cart information 166 may include information about the grain cart 110 and/or the material in the grain cart that is to be transferred. Thus, the cart information 166 can include the crop type 168 of material in the grain cart 110, the crop weight 170 of that material, crop characteristics (such as crop moisture or other characteristics), among other information 174. In one example, the cart information 166 can be sent along with, or in addition to the unloading configuration approval request 128 so that operator/user 132 can view the cart information 166 as well as the unload configuration parameters.

Communication system 144 enables communication of the items in approval system 122 relative to one another, and also enables communication of system 122 with remote system 126 and possibly other systems. Thus, communication system 144 can include a controller area network (CAN) bus and bus controller, a cellular communication system, a wide area network or a local area network communication system, a Wi-Fi or Bluetooth communication system, a near field communication system, among any of a wide variety of other communication systems or combinations of systems.

Location sensor 178 can be a sensor that senses the location of system 122 in a global or local coordinate system. Therefore, location sensor 178 can be a global navigation satellite system (GNSS) receiver, a cellular triangulation system, a dead reckoning system, accelerometers and/or inertial measurement units, or any of a wide variety of other location systems. Image sensors 180 can include image capture devices, such as stereo cameras, mono cameras, infrared cameras, among other sensors. The image sensor(s) 180 may be mounted on material transfer vehicle 106, on an unmanned aerial or other vehicle, or elsewhere. Image sensors 180 may also include image processing functionality so that the images can be processed to identify items in the image, and/or characteristics of the image. Weight sensors 182 illustratively sense the weight of material in grain cart 110. Therefore, weight sensors 182 can be scales or load cells, weight estimation systems that sense or obtain, for example, crop moisture and crop volume and generate a weight estimate, or other sensors. Weight sensors 182 may be mounted in the axles of grain cart 110 or elsewhere. Other sensors 184 can include any of a wide variety of other sensors, such as ultrasonic sensors, LIDAR sensors, RADAR sensors, and/or any of a wide variety of other sensors that sense various items and generate an output indicative of the sensed items. Each of the sensors 146 may generate a sensor signal that is indicative of the sensed item. The sensor signals can be conditioned (e.g., filtered, amplified, normalized, linearized, aggregated, or otherwise processed) and output to one or more other components on system 122, or other components.

User interface mechanisms 147 can include a wide variety of different types of user interface mechanisms that allow an operator of material transfer vehicle 106 to control and manipulate portions of material transfer vehicle 106. The operator may be a human operator and/or an autonomous control system. For instance, user interface mechanisms 147 can include a steering wheel, joysticks, knobs, levers, linkages, pedals, display devices, speech recognition and/or speech synthesis functionality, touch sensitive display screens, point and click devices, among other things. Where user interfaces mechanisms 147 include displays on a display device, those displays can include user actuatable mechanisms such as icons, links, buttons, drop down menus, etc. The mechanisms can be actuated by using a point and click device, touch gestures, speech inputs, etc. User interface mechanisms 147 can include any of a wide variety of other audio, visual, and/or haptic mechanisms that generate outputs to the operator and/or receive inputs from the operator.

Unload approval processing system 148 generates approval request 128 and processes response 134. Trigger detector 186 detects a trigger indicating that an approval request 128 should be generated and sent to remote system 126. Trigger detector 186 can detect the trigger based upon the location of material transfer vehicle 106 (e.g., as sensed by location sensor 178). For instance, a trigger may be detected when material transfer vehicle 106 reaches a predefined location (which may be defined by an operator or user identifying it on a map, entering coordinates, dropping a flag in a mapping system, driving to that location and setting the location in the navigation system of material transfer vehicle 106, or in other ways). This may indicate that unload approval processing system 148 is to begin to generate an approval request 128 and transfer it to remote system 126. In another example, trigger detector 186 may detect a trigger when a container (e.g., a semi-trailer 118) is identified by image sensor 180 or another sensor. Once the semi-trailer is identified, then this may be detected as a trigger to indicate that an approval request 128 should be sent. Trigger detector 186 can detect a trigger based on an operator input or in other ways as well.

Approval request generator 188 generates the unloading configuration approval request 128 for transmission to remote system 126. Configuration data generator 196 generates or obtains unload configuration data (such as data 156) that includes the configuration parameters describing the desired unload operation that material transfer vehicle 106 wishes to perform with respect to the haulage vehicle 118 or other container. The configuration data 156 can be obtained and formatted for transmission as approval request 128. Where the unload configuration data 156 is not yet stored, that data may be obtained from sensors 146 or in other ways. For instance, the weight of the material may be obtained from weight sensors 182, the target distribution data 160 may be obtained based upon the type of haulage vehicle that was identified through image sensors 180, etc. Other data generator 198 can generate other data that may be sent along with, or in addition to, approval request 128. For instance, that data may include cart information 166 which again is stored, or generated by, sensors 146 or obtained in other ways, and image data generated by image sensor(s) 180.

Once the approval request 128 is generated, it can be provided from unload approval processing system 148 to communication system 144 for transmission to remote system 126. The particular remote system 126 that is to receive the approval request 128 may be identified by an operator, preconfigured, or identified in other ways.

Response processing system 190 then receives and processes a response 134. For instance, when the response 134 indicates that operator/user 132 has approved the request 128, then an indication of this can be output from system 190 to unloading control signal generator 150 so that control signals 204 can be generated to perform the unloading operation. Where the response 134 indicates that the unloading operation has been cancelled by operator/user 132, then an indication of this can be output from system 190 to unloading control signal generator 150 to generate control signals 204 controlling material transfer vehicle 106 to stay in a current position and wait for further instructions, or to perform other operations. Where the response 134 includes modified configuration parameters, then configuration modification processor 200 modifies the unload configuration data 156 and triggers approval request generator 188 to generate another approval request 128 using the modified configuration parameters.

When an unload operation has been completed, unload summary generator 192 generates a summary indicative of information describing the unload operation. That information can include such things as the type of crop that was transferred to haulage vehicle 118, the actual unloaded weight, the average crop moisture of material unloaded into haulage vehicle 118, the unload start time and date, the unload end time and date, the destination of haulage vehicle 118, the field or location from which the crop was harvested, the final fill profile within the semi-trailer 120, among other things.

Unloading control signal generator 150 generates control signals 204 to control subsystems on material transfer vehicle 106. Thus, control signals 204 can control actuators (such as motors, transmissions, etc.) to propel material transfer vehicle 106 in the forward or rearward direction, to steer material transfer vehicle 106, to control the position of unloading auger 112 and spout 114, the unloading conveyor (such as to start and stop the power takeoff which drives the unloading auger, as well as to control the speed of the power takeoff), and/or any of a wide variety of other subsystems. Unloading control signal generator 150 can be an automated system, a manual system, or a semi-automated system in which some functions are fully or partially automated while others are not.

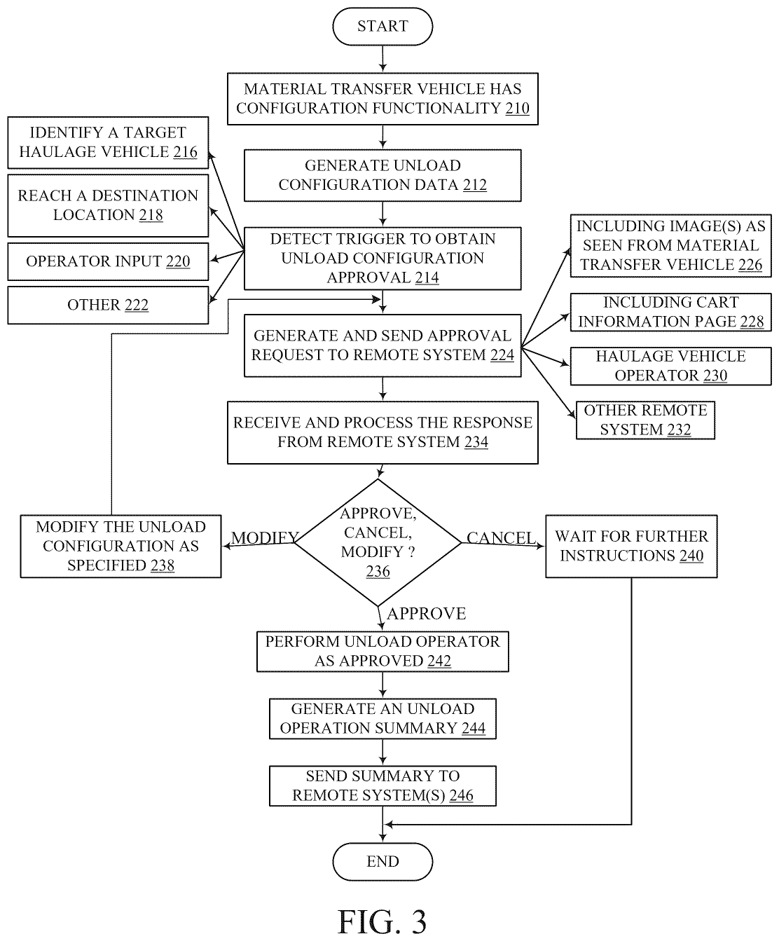

FIG. 3 is a flow diagram illustrating one example of the operation of unload configuration/approval system 122 in more detail. It is first assumed that material transfer vehicle 106 has the configuration functionality of unload configuration/approval system 122, or has access to that functionality, as indicated by block 210 in the flow diagram of FIG. 3. Configuration data generator 188 can be generating the unload configuration data 156 even before trigger detector detects a trigger to send an approval request 128. Therefore, as the material is being carried by material transfer vehicle 106, both configuration data generator 196 and other data generator 198 can be generating the unload configuration data 156 and cart information 166. Generating such data is indicated by block 212 in the flow diagram of FIG. 3.

At some point, trigger detector 186 will detect a trigger to generate an approval request 128 to obtain approval of the unload configuration. Detecting a trigger is indicated by block 214 in the flow diagram of FIG. 3. The trigger can be detected when image sensor 180 detects a target haulage vehicle 118, as indicated by block 216 in the flow diagram of FIG. 3. The trigger can be detected when material transfer vehicle 106 reaches a desired location, as output by location sensor 178, and as indicated by block 218 in the flow diagram of FIG. 3. The trigger can 19 be detected based on an operator input, as indicated by block 220, or in other ways, as indicated by block 222.

Based upon the detected trigger, approval request generator 188 generates and sends an approval request 128 to remote system 126. Generating the approval request 128 is indicated by block 224 in the flow diagram of FIG. 3. In one example, approval request 128 includes, or is sent along with, images captured by image sensor 180. The image sensor 180 may be a camera mounted on material transfer vehicle 106 so the image is as seen from material transfer vehicle 106. The cameras may be deployed as forward looking perception cameras, sideward looking perception cameras, cameras on auger 112, or spout 114 or elsewhere on grain cart 110, or on tractor 108 or elsewhere. Therefore, the operator or user 132 may be able to see a view from the perspective of material transfer vehicle 106 as captured by image sensors 180. Sending the sensed images seen from material transfer vehicle 106 along with the approval request 128 is indicated by block 226 in the flow diagram of FIG. 3. The approval request 128 can also include cart information or cart data 166, as indicated by block 228.

The approval request can be displayed or otherwise made accessible to operator/user 132, who may be an operator or user of haulage vehicle 118 (and which also may be a manual or automated operator or user), or an operator or user of another remote system. Surfacing the approval request 128 for the haulage vehicle operator is indicated by block 230, and surfacing the approval request 128 for an operator or user at another remote system is indicated by block 232 in the flow diagram of FIG. 3. The remote system 126 sends a response 134 to the approval request 128, as discussed in detail elsewhere herein.

Response processing system 190 then receives and processes the response 134 from remote system 126. Receiving and processing the response from the remote system 126 is indicated by block 234 in the flow diagram of FIG. 3. As discussed above, response 134 will indicate that the approval request 128 is approved, cancelled, or modified. Determining whether the response indicates the approval request has been modified (e.g., the unloading configuration parameters are modified in response 134) is indicated at block 236. If the response 134 indicates that the approval request 128 has been modified, then configuration modification processor 300 modifies the unloading configuration parameters as specified in the response 134. Modifying the unload configuration parameters is indicated by block 238. Processing then reverts to block 224 where approval request generator 188 generates and sends another approval request 128 with the modified configuration parameters.

If, at block 236, it is determined that the response 134 cancels the unloading approval request 128, then system 190 indicates this to unloading control signal generator 150 which generates control signals to control material transfer vehicle 106 to wait for further instructions or to perform some other operation, as indicated by block 240 in the flow diagram of FIG. 3.

If, at block 236, response processing system 190 determines that the response 134 is to approve the approval request 128, then system 190 generates an output indicative of this to unloading control signal generator 150 which generates control signals 204 to control material transfer vehicle 106 to perform the unload operation according to the approved configuration. The control signals 204 can control controllable subsystems on material transfer vehicle 106 to execute the unloading operation. Performing the unload operation according to the approved configuration parameters is indicated by block 242 in the flow diagram of FIG. 3.

When an unload operation has been performed, unload summary generator 192 generates an unload summary as indicated by block 244 in the flow diagram of FIG. 3. Unload summary generator 192 then invokes communication system 134 to send the unload summary to the remote system 126. Sending the summary to the remote system is indicated by block 246 in the flow diagram of FIG. 3.

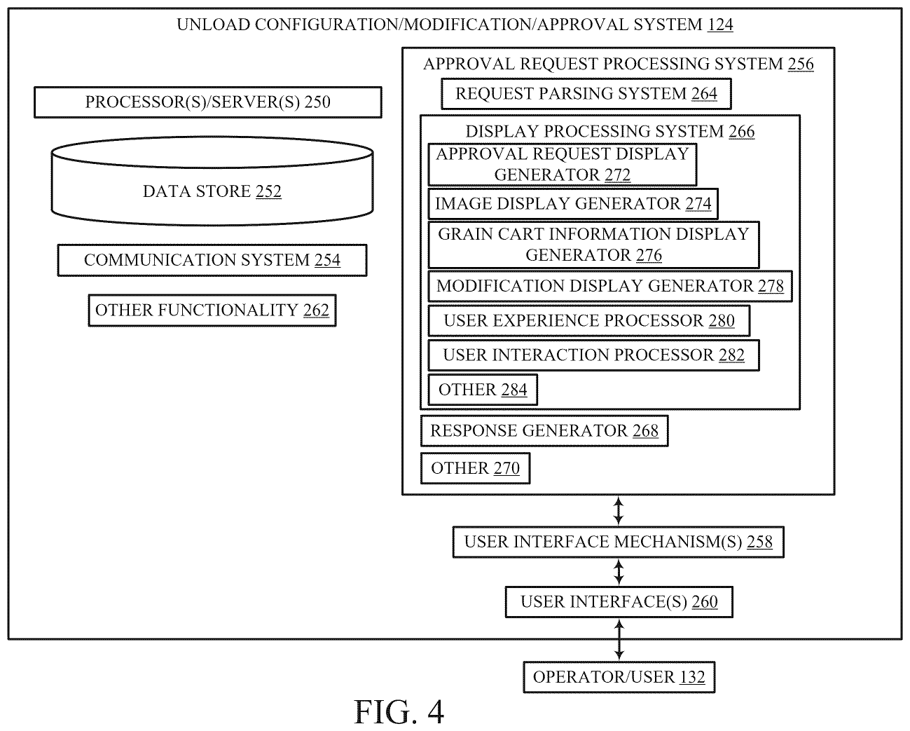

FIG. 4 is a block diagram showing one example of the unload configuration/modification/approval system 124 at remote system 126.

In the example shown in FIG. 4, system 124 includes one or more processors or servers 250, data store 252, communication system 254, approval request processing system 256, user interface 11 mechanisms 258 that may generate one or more user interfaces 260, and any of a wide variety of other functionality 262. Approval request processing system 256 can include request parsing 13 system 264, display processing system 266, response generator 268, and other items 270. In the example shown in FIG. 4, display processing system 260 can include request display generator 272, image display generator 274, grain cart information display generator 276, modification display generator 278, user experience processor 280, user interaction processor 282, and other items 284. Before describing the overall operation of system 124, a description of some of the items in system 124, and their operation, will first be provided.

Communication system 254 can be similar to, or different from, communication system 144, depending on the type of communication it facilitates. Approval request processing system 256 receives unloading configuration approval requests 128 and processes those requests to display them or otherwise surface them for operator/user 132 on user interfaces 260. User interaction processor 280 detects the user interactions with the approval request 128 and response generator 268 generates a response 134 based upon those user interactions.

In one example, user experience processor 280 receives the approval request 128 and navigates operator/user 132 through a user experience based upon the detected user interactions. For instance, user experience processor 280 can control request display generator to generate the approval request on a user interface 260. Image display generator 274 may be controlled to display, on a user interface 260, the image that is captured by one or more of the image sensors 180 on material transfer vehicle 106 so that operator/user 132 can see a view from the perspective of material transfer vehicle 106. Grain cart information display generator 276 can be controlled to display the grain cart information 166 that may be sent along with, or in addition to, approval request 128. Modification display generator 278 can be controlled to display a modification user interface display with user actuatable input mechanisms that are actuatable by operator/user 132 to modify the unloading configuration parameters provided in approval request 128 in order to generate modified or changed unloading configuration parameters. User interaction processor 280 detects user interactions with the various displays and user actuatable input mechanisms so that response generator 268 can generate response 134.

User interface mechanisms 258 can include a wide variety of different types of user interface mechanisms that allow operator/user 132 to control and manipulate remote system 126 and portions of material transfer vehicle 106. For instance, user interface mechanisms 258 can 11 include a steering wheel, joysticks, knobs, levers, linkages, pedals, display devices, speech recognition and/or speech synthesis functionality, touch sensitive display screens, point and click devices, among other things. Where user interfaces 260 include displays on a display device, those displays can include user actuatable mechanisms such as icons, links, buttons, drop down menus, etc. The mechanisms can be actuated by using a point and click device, touch gestures, speech inputs, etc. User interface mechanisms 258 can include any of a wide variety of other audio, visual, and/or haptic mechanisms that generate outputs to operator/user 132 and/or receive inputs from operator/user 132.

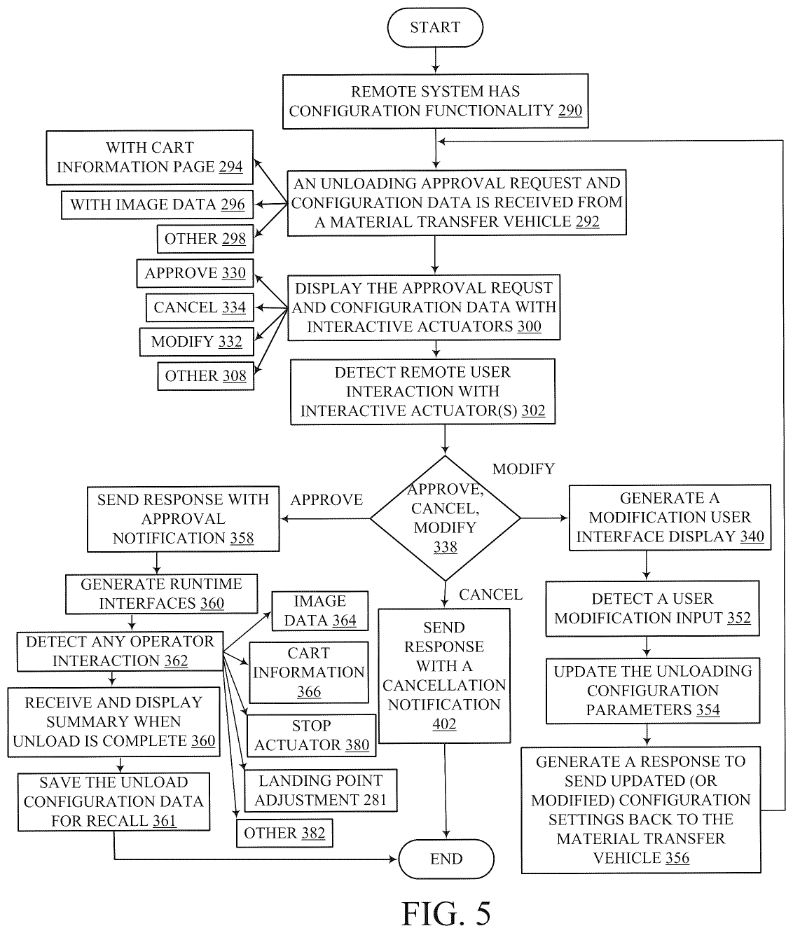

FIG. 5 is a flow diagram illustrating one example of the operation of unload configuration/modification/approval system 124 in more detail. It is first assumed that remote system 126 has the functionality corresponding to system 124, as indicated by block 290 in the flow diagram of FIG. 5. In one example, approval request processing system 256 receives an approval request 128, through communication system 254, from material transfer vehicle 106. Receiving an approval request 128 is indicated by block 292 in the flow diagram of FIG. 5. As discussed above, approval request 128 includes the unloading configuration parameters which can be viewed or otherwise accessed by operator/user 132 at remote system 126. In one example, the approval request 128 can be accompanied by, or include, information from a cart information page (e.g., cart information 166) as indicated by block 294 in the flow diagram of FIG. 5. The approval request 128 can also include, or by accompanied by, image data generated from image sensors 180 so that the operator/user 132 can review an image from the perspective of material transfer vehicle 106. Receiving image data is indicated by block 296 in the flow diagram of FIG. 5. The approval request can be received in other ways and include information as well, as indicated by block 298.

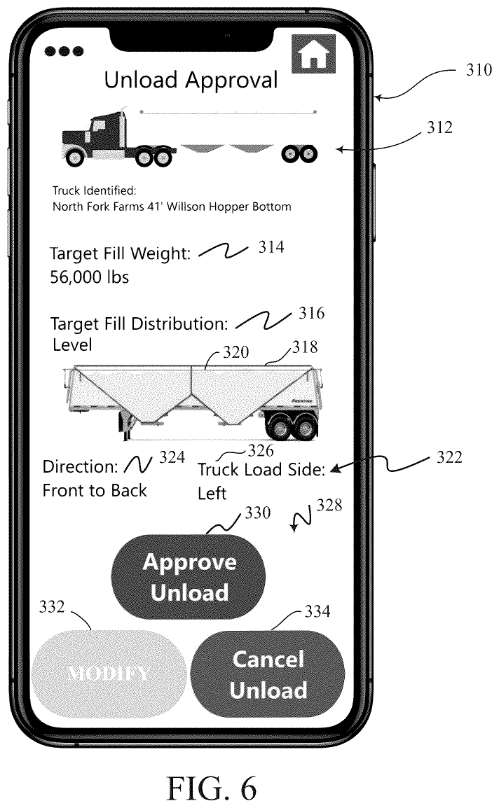

Request parsing system 264 then parses the approval request 128 to obtain the information corresponding to the configuration parameters and provides that information to display processing system 266. Approval request display generator 272 displays the approval request 128 and the configuration data with interactive actuators that can be actuated by operator/user 132. Displaying the approval request in an interactive fashion is indicated by block 300 in the flow diagram of FIG. 5. In one example, in addition to displaying the configuration parameters, the display can display an approve actuator 330, a cancel actuator 334, a modify actuator 332, and any of a wide variety of other actuators 308. One example of such a display is shown in FIG. 6.

FIG. 6 shows one example of a user interface display 310 that is displayed on the display screen of a mobile device. Display 310 displays the configuration parameters which include a vehicle identification portion 312 that displays the type of haulage vehicle 118 (or other container) that has been identified by material transfer vehicle 106, and into which the material transfer vehicle 106 expects to unload material. Display 310 also includes a target fill weight display portion 314 that displays the weight of material that material transfer vehicle 106 expects to transfer to the identified haulage vehicle 118 or other container. Display 310 includes a target fill distribution display portion 316 that displays a target fill level to which material transfer vehicle expects to load haulage vehicle 118 or other container. In the example shown in FIG. 6, for instance, target fill distribution display portion 316 displays a representation 318 of the semi-trailer 120, along with a fill distribution marker 320 which indicates the estimated fill level and distribution of material to be loaded into semi-trailer 120. Display 310 also includes a fill pattern display portion 322 which displays characteristics of the fill pattern to be executed by material transfer vehicle 106 in performing the unloading operation. In the example shown in FIG. 6, fill pattern display portion 322 includes a direction display portion 324 which indicates that the unloading operation is to be performed in a front-to-back manner, and a truck load side display portion 326 which indicates that material transfer vehicle 106 expects to unload material into the truck from the left side of the truck (e.g., from the driver side of the truck). Display 310 also includes an actuator display portion 328 which displays user actuatable mechanisms for interaction by operator/user 132. The actuators shown in actuator display portion 328 include an approve actuator 330, a modify actuator 332, and a cancel unload actuator 334.

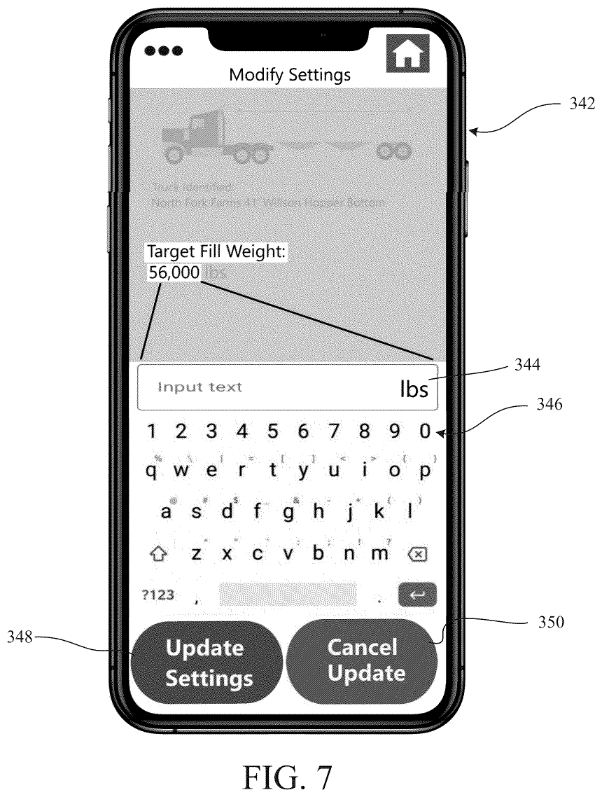

Returning again to the description of FIG. 5, user interaction processor 280 detects user interaction with any of the actuators 330, 332, and/or 334 on display 312. Detecting user interaction is indicated by block 336 in the flow diagram of FIG. 5. At block 338, user experience processor 208 determines whether the user has actuated the approve, cancel, or modify actuators, as indicated by block 338 in the flow diagram of FIG. 5. Assume first that user interaction processor 280 determines that the operator/user 132 has actuated the modify actuator 332. In that case, processor 280 generates an output indicating this to modification display generator 278. In response, modification display generator 278 generates a modification user interface display for interaction by operator/user 132 in order to modify the unload configuration parameters. Generating a modification user interface display is indicated by block 340 in the flow diagram of FIG. 5. One example of such a display is shown in FIG. 7.

FIG. 7 shows one example of a modification user interface display 342 that can be generated by modification display generator 278, in response to operator/user 132 actuating the modify actuator 332 shown in FIG. 6. In one example, based on the operator/user 132 actuating the modify actuator 332, then modification display generator 278 makes the configuration parameters displayed on display 310 (in FIG. 6) selectable by the user for modification. In the example shown in FIG. 7, the user has selected the target fill weight display portion 314 for modification. In response, modification display generator 278 generates a text box 344 and a virtual keyboard 346 that can be actuated to update the target fill weight configuration parameter. Thus, operator/user 132 can enter a new target fill weight to modify the unload configuration parameter sent with the original approval request 128. Once operator/user 132 has entered the desired new target fill weight, the operator/user 134 can actuate an update settings actuator 348 to update the settings. The operator/user 132 may also cancel the modification process by actuating a cancel update actuator 350. In one example, operator/user 132 can select any of the configuration parameters displayed with the unloading configuration approval request 128 for modification modify them, and then update the parameters.

User interaction processor 280 detects the user modification inputs, as indicated by block 352 in the flow diagram of FIG. 5, and response generator 268 then generates a response 134 and calls communication system 254 to send the response 134, with the modified or updated configuration parameter values, back to the material transfer vehicle load configuration/approval system 122. Updating or modifying the unloading configuration parameters is indicated by block 354 in the flow diagram of FIG. 5, and generating and sending a response 134 with those updated parameters back to the material transfer vehicle unload configuration/approval system 122 is indicated by block 356 in the flow diagram of FIG. 5. Processing then reverts to block 292 where approval request processing system 256 waits to receive an updated or modified approval request 128 which includes the modified configuration parameters.

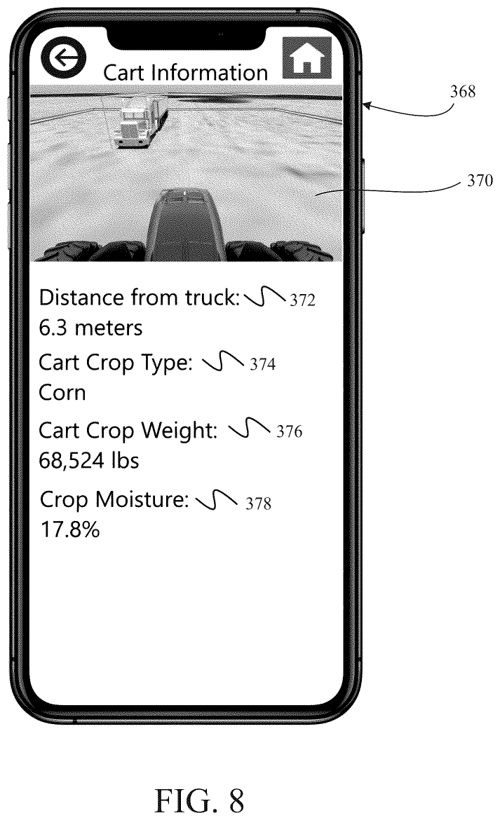

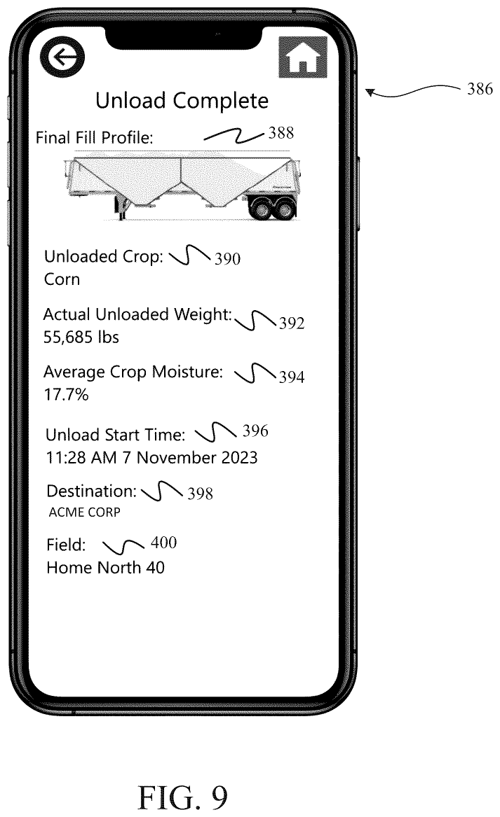

Assume, at block 338, that user interaction processor 280 detects a user interaction in which operator/user 132 actuates the approve unload actuator 330. In that case, user interaction processor 280 generates an output to communication system 254 to send a response 134 with the approval notification, as indicated by block 358 in the flow diagram of FIG. 5. Display processing 11 system 266 then generates the normal runtime interfaces for operator/user 132 that are displayed during the unloading process, as indicated by block 360 in the flow diagram of FIG. 5. It will be also appreciated that, at any time during operation, operator/user 132 can provide inputs requesting other information to be displayed, as indicated by block 362. For instance, operator/user 132 can actuate a user actuatable input mechanism that is detected by user interaction processor 280 as requesting a display of image data generated by image sensor 180 on material transfer vehicle 106. In that case, image display generator 274 displays the image data so that operator/user 132 can obtain a view as seen from the perspective of material transfer vehicle 106. Displaying such image data is indicated by block 364 in the flow diagram of FIG. 5. In another example, operator/user 132 may actuate a user actuatable input mechanism, that is detected by user interaction processor 280, to display cart information 166. In that case, processor 280 generates an output to grain cart information display generator 276 to generate such a display of cart information, as indicated by block 366 in the flow diagram of FIG. 5. One example of such a display is shown in FIG. 8.

FIG. 8 shows one example of a display 368 that shows cart information 166. In the example shown in FIG. 8, an image display portion 370 displays an image from an image sensor 180 located on material transfer vehicle 106. The image display portion 370 displays the image from the perspective of material transfer vehicle 106 to operator/user 132. Display 368 also includes a distance display portion 372 that displays the distance that material transfer vehicle 106 is from the haulage vehicle 118. Display 368 includes a crop type display portion 374 that displays the crop type carried by grain cart 110, a cart crop weight display portion 376 that displays the crop weight carried by grain cart 110, as well as a crop moisture display portion 378 that displays an average crop moisture for the crop in grain cart 110.

Also, operator/user 132 may actuate a stop actuator 380 to stop the unloading process. The stop actuator may be an emergency stop actuator in which case the unloading process is immediately stopped, or a slow stop actuator in which case the material transfer vehicle 106 can be stopped in a different sequence, such as more slowly, or according to another stop profile (e.g., the rate at which the vehicle 106 is stopped can change, the sequence in which systems on vehicle 106 are stopped or powered down can change, among other things.)

In another example, operator/user 132 can activate an adjustment actuator to adjust the landing point of material in haulage vehicle 118. For instance, user interaction processor 282 can detect interaction with an adjustment actuator to move the landing point of material forward or backward in haulage vehicle 118, in which case an indication that the adjustment actuator has been actuated is communicated by communication systems 254 and 144 to unloading control signal generator 150 which generates control signals to control the propulsion subsystem to move grain cart 110 forward or backward relative to haulage vehicle 118. In another example, the landing point can be changed by controlling spout/flap actuators that change the position of the spout/flap, by controlling the steering subsystem on tractor 108, by controlling the speed of the unloading conveyor to change the trajectory of material exiting spout 112, or by controlling other subsystems. Making a loading point adjustment is indicated by block 281 in the flow diagram of FIG. 5. Other operator interactions can be detected as well, as indicated by block 382 in the flow diagram of FIG. 5.

Once the unload operation is complete, as discussed above with respect to FIG. 3, unload summary generator 192 in unload configuration/approval system 122 generates and sends an unload summary. Display processing system 266 can generate a display displaying the unload summary for operator/user 132, as indicated by block 384 in the flow diagram of FIG. 5. Such an interface is shown in FIG. 8.

FIG. 8 shows one example of a user interface display 386 that displays summary information corresponding to an unload operation. Display 386 includes a final fill profile display portion 388 that displays the final fill profile in the haulage vehicle 118 or other container. Display includes a crop type display portion 390 that displays the type of crop that was loaded into the container or haulage vehicle 118 and an actual unloaded weight display portion 392 that displays the actual weight of material loaded into the haulage vehicle 118 or other container. Display 386 includes an average crop moisture display portion 394 displaying the average crop moisture of the material, as well as a load time display portion 396 that can display the start time and/or end time of the unload operation. Display 386 includes a destination display portion 398 that displays an expected destination of the haulage vehicle 118 or other container and a field display portion 400 that displays an indicator of the field or location from which the crop was harvested. The summary of the unloading operation can be stored or sent to other systems for other use as well. Also, in one example, the values of the unload configuration data can be saved and recalled the next time the haulage vehicle 118 or container is to be loaded. Saving the unload configuration data for later use is indicated by block 361 in the flow diagram of FIG. 5.

If, at block 338 in FIG. 5, user interaction processor 280 determines that operator/user 132 has actuated the cancel unload actuator 334 shown in FIG. 6, then response generator 268 generates and sends a cancellation notice as a response 134, as indicated by block 402 in the flow diagram of FIG. 5.

It can thus be seen that the present description describes a system which enables an operator/user at a remote system to approve, cancel, or modify configuration parameters corresponding to an unload operation. The present description also describes a system that allows 17 the remote operator/user to see an image taken from the perspective of the material transfer vehicle, and also to review information about the material to be transferred, and about the unloading operation that is about to take place. This greatly increases the accuracy of the unloading operations, reduces downtime and spillage, as well as other potential errors, such as overfilling a container, filling a container with a weight in excess of capacity, etc.

It will also be noted that, while a plurality of user interface displays have been described, they are described for the sake of example only. Additional or different information may be displayed on the displays.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated 6 using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, detectors, and/or logic. It will be appreciated that such systems, components, generators, detectors, and/or logic can be comprised of hardware items (such as processors and associated memory, or other processing components, some of which are described below) that perform the functions associated with those systems, components, generators, detectors, and/or logic. In addition, the systems, components, generators, detectors, and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components, generators, detectors, and/or logic described above. Other structures can be used as well.

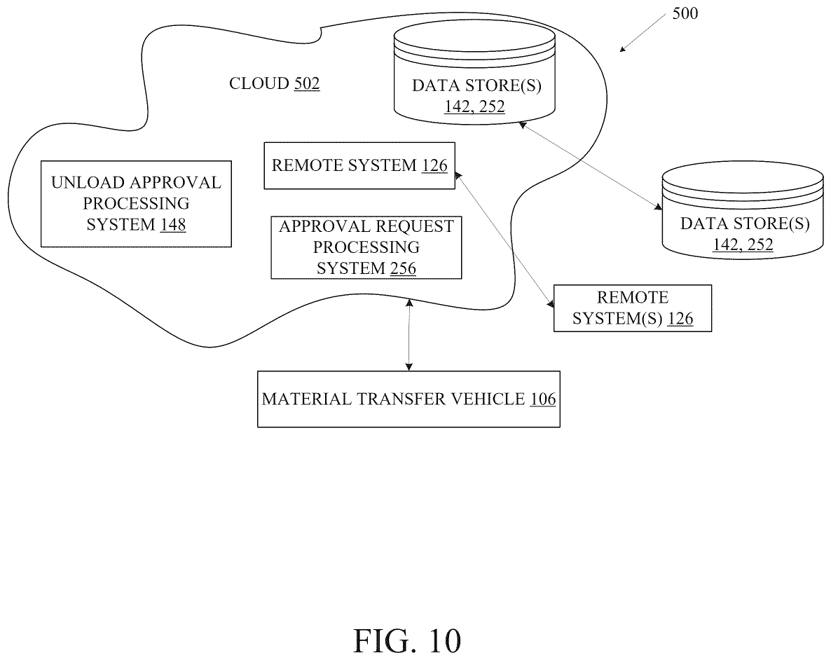

FIG. 10 is a block diagram of agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or the components and functions can be installed on client devices directly, or in other ways.

In the example shown in FIG. 10, some items are similar to those shown in previous FIGS. and they are similarly numbered. FIG. 10 specifically shows that approval request processing system 256 and unload approval processing system 148 and data stores 142, 252 can be located at a remote server location 502. Therefore, machine 106 and system 126 can access those systems through remote server location 502.

FIG. 10 also depicts another example of a remote server architecture. FIG. 10 shows that it is also contemplated that some elements of previous FIGS are disposed at remote server location 502 while others are not. By way of example, data stores 142, 252 or parts of systems 122, 124 can be disposed at a location separate from location 502, and accessed through the remote server at location 502. Regardless of where the items are located, the items can be accessed directly by components of system 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

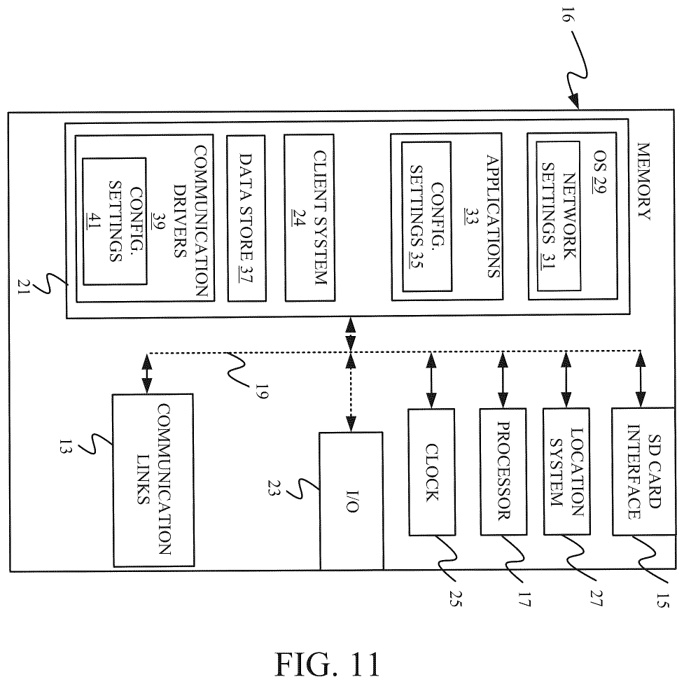

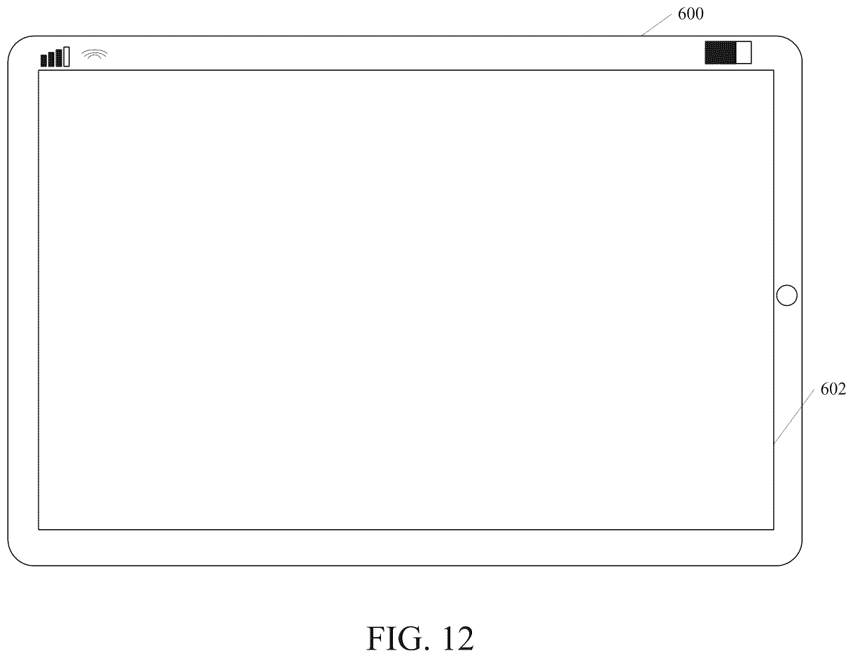

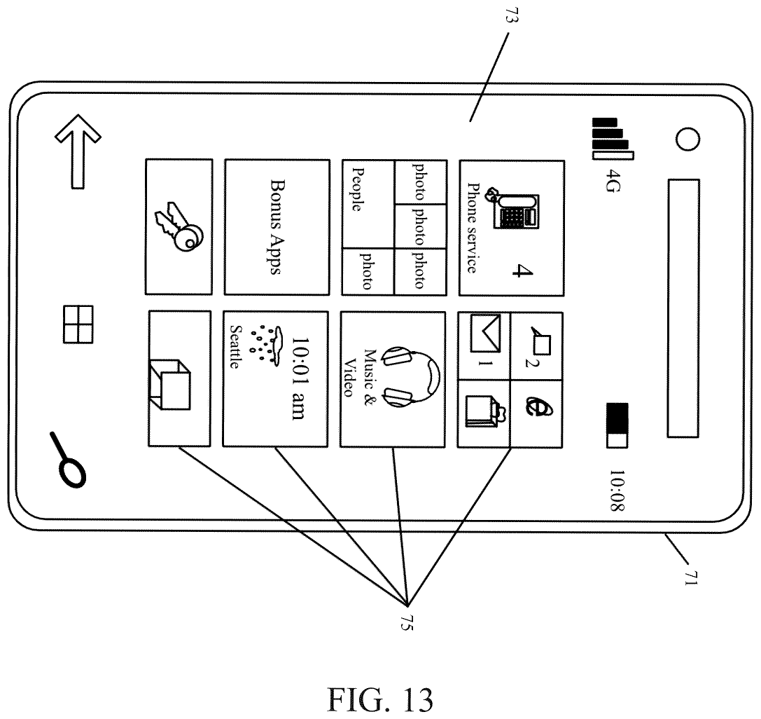

FIG. 11 is a simplified block diagram of one illustrative example of a handheld or mobile computing device that can be used as a user's or client's hand held device 16, in which the present system (or parts of it) can be deployed. For instance, a mobile device can be deployed in the operator compartment of vehicle 106, vehicle 118 or in system 106 for use in generating, processing, or displaying the unloading data. FIGS. 12-13 are examples of handheld or mobile devices.

FIG. 11 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. Clock 25 can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according 11 to the instructions. Processor 17 can be activated by other components to facilitate their functionality as well.

FIG. 12 shows one example in which device 16 is a tablet computer 600. In FIG. 12, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 13 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

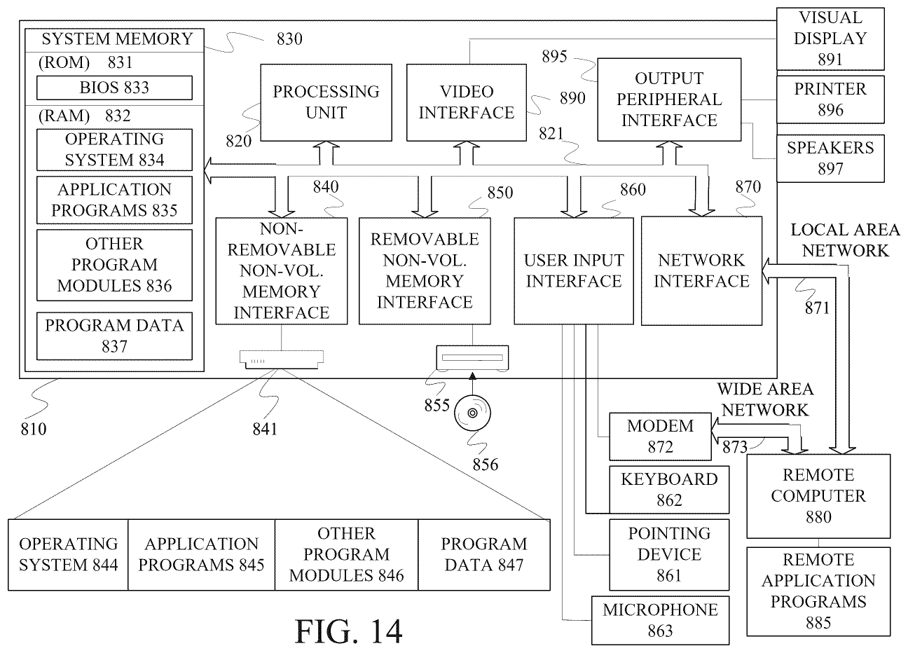

FIG. 14 is one example of a computing environment in which elements of previous FIGS., or parts of it, (for example) can be deployed. With reference to FIG. 14, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media May embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 14 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving an approval request from an approval system corresponding to a material transfer vehicle, the approval request including a plurality of unloading configuration parameters corresponding to an unloading operation for unloading material from the material transfer vehicle into a container;
controlling a display device to display the plurality of unloading configuration parameters at a remote system, remote from the material transfer vehicle, along with a set of actuators including a modify actuator and an approve actuator;
detecting user interaction with a selected actuator in the set of actuators; and
generating a control signal to control a communication system to send a response to the approval system corresponding to the material transfer vehicle based on the detected user interaction.

2. The computer implemented method of claim 1 and further comprising:
generating a control signal to control an unloading subsystem on the material transfer vehicle based on the response.

3. The computer implemented method of claim 1 wherein detecting user interaction comprises:
detecting user actuation of the modify actuator;
generating a parameter modification interface with a user actuatable modification element that is actuatable to modify a selected unloading configuration parameter, of the plurality of unloading configuration parameters; and
detecting user interaction with the user actuatable modification element to obtain a modified parameter value.

4. The computer implemented method of claim 3 wherein generating a control signal to control the communication system to send a response comprises:
generating the response to indicate the modified parameter value; and
generating the control signal to control the communication system to send the response.

5. The computer implemented method of claim 3 wherein generating a parameter modification interface comprises:
generating a user actuatable modification element corresponding to each of a plurality of unloading configuration parameters.

6. The computer implemented method of claim 5 wherein the plurality of unloading configuration parameters comprises a container identification parameter indicative of a container and wherein generating a parameter modification interface comprises:
generating a user actuatable modification element that is actuatable to modify the container identification parameter to change an identify of the container.

7. The computer implemented method of claim 5 wherein the plurality of unloading configuration parameters comprises a material weight parameter indicative of a target weight of material to be transferred from the material transfer vehicle to the container during the unloading operation and wherein generating a parameter modification interface comprises:
generating a user actuatable modification element that is actuatable to modify the material weight parameter to change the target weight of material.

8. The computer implemented method of claim 5 wherein the plurality of unloading configuration parameters comprises a fill profile parameter indicative of a target distribution of material to be transferred from the material transfer vehicle to the container during the unloading operation and wherein generating a parameter modification interface comprises:
generating a user actuatable modification element that is actuatable to modify the fill profile parameter to change the target distribution of material.

9. The computer implemented method of claim 5 wherein the plurality of unloading configuration parameters comprises a fill pattern parameter indicative of a target fill pattern to be followed by the material transfer vehicle in performing the unloading operation and wherein generating a parameter modification interface comprises:
generating a user actuatable modification element that is actuatable to modify the fill pattern parameter to change the target fill pattern to be followed by the material transfer vehicle in performing the unloading operation.

10. The computer implemented method of claim 1 and further comprising:
receiving at the remote system, image data indicative of an image captured by an image sensor, the image being from a perspective of the material transfer vehicle; and
generating an image display at the remote system based on the image data.

11. The computer implemented method of claim 1 wherein the container comprises a haulage vehicle and where the remote system comprises a remote computing system that is remote from the material transfer vehicle and remote from the haulage vehicle and wherein controlling a display device comprises at least one of:
controlling a display device on a mobile device;
controlling a display device mounted in an operator compartment of the haulage vehicle; or
controlling a display device at the remote computing system.

12. The computer implemented method of claim 1 and further comprising:
detecting user activation of a user adjustment actuator, during the unloading operation, to change a landing point of the material in the container; and
controlling the communication system to send an adjustment communication to the material transfer vehicle to change the landing point.

13. The computer implemented method of claim 1 and further comprising:
detecting, during the unloading operation, user activation of a stop actuator to stop the unloading operation; and
controlling the communication system to send a stop communication to the material transfer vehicle to stop the unloading operation.

14. A computer implemented method, comprising:
generating an unloading configuration approval request at an approval system corresponding to a material transfer vehicle, the unloading configuration approval request including a plurality of unloading configuration parameters corresponding to an unloading operation for unloading material from the material transfer vehicle into a container;
controlling a communication system to send the unloading configuration approval request to a remote system;
receiving a response to the unloading configuration approval request from the remote system; and
controlling an unloading subsystem on the material transfer vehicle based on the response to the unloading configuration approval request.

15. The computer implemented method of claim 14 wherein receiving the response comprises receiving a modified unloading configuration parameter value and wherein controlling the unloading subsystem comprises:
modifying the unloading configuration parameter based on the modified unloading configuration parameter value in the response; and
controlling the unloading subsystem based on the modified unloading configuration parameter.

16. The computer implemented method of claim 15 wherein the material transfer vehicle comprises a grain cart and further comprising:
generating a set of grain cart data indicative of characteristics of material in the grain cart to be unloaded during the unloading operation; and
controlling the communication system to send the grain cart data to remote system.

17. The computer implemented method of claim 15 wherein controlling the unloading subsystem comprises performing the unloading operation to unload the material into the container, and further comprising:
generating an unloading summary including unload data indicative of characteristics of the unloading operation; and
controlling the communication system to send the unloading summary to the remote system.

18. The computer implemented method of claim 15 and further comprising:
capturing image data with an image sensor mounted on the material receiving vehicle, the image data being indicative of an image of the container; and
controlling the communication system to send the image data to the remote system.

19. An agricultural system, comprising:
at least one processor; and
a data store storing computer executable instructions which, when executed by the at least one processor, cause the at least one processor to perform steps, comprising:
generating an unloading configuration approval request at an approval system corresponding to a material transfer vehicle, the unloading configuration approval request including a plurality of unloading configuration parameters corresponding to an unloading operation for unloading material from the material transfer vehicle into a container;
controlling a first communication system to send the unloading configuration approval request to a remote system that is remote from the material transfer vehicle;
receiving the unloading configuration approval request at the remote system;
controlling a display device to display the plurality of unloading configuration parameters at the remote system along with a set of actuators including a modify actuator and an approve actuator;
detecting user interaction with a selected actuator in the set of actuators; and
generating a control signal to control a second communication system to send a response, to the unloading configuration approval request, to the approval system corresponding to the material transfer vehicle based on the detected user interaction;
receiving, at the approval system corresponding to the material transfer vehicle, the response to the unloading configuration approval request; and
controlling an unloading subsystem on the material transfer vehicle based on the response to the unloading configuration approval request.

20. The agricultural system of claim 19 wherein detecting user interaction with the selected actuator comprises:
detecting user actuation of the modify actuator;
generating a parameter modification interface with a user actuatable modification element that is actuatable to modify a selected unloading configuration parameter, of the plurality of unloading configuration parameters; and
detecting user interaction with the user actuatable modification element to obtain a modified unloading configuration parameter value, and wherein receiving the response comprises receiving the modified unloading configuration parameter value and wherein controlling the unloading subsystem comprises:
modifying the unloading configuration parameter based on the modified unloading configuration parameter value in the response; and
controlling the unloading subsystem based on the modified unloading configuration parameter.
